(19) United States
(12) Patent Application Publication
(10) Pub. No.: US 2026/0307358 A1
(43) Pub. Date: Oct. 8, 2026

(54) RIBLET STRUCTURE, AND METHOD FOR PRODUCING SUCH A RIBLET STRUCTURE

(71) Applicant: Peter Adrian LEITL, Graz (AT)

(72) Inventor: Peter Adrian LEITL, Graz (AT)

(21) Appl. No.: 19/482,532

(22) PCT Filed: May 2, 2024
(86) PCT No.: PCT/AT2024/060181

§ 371 Date: Nov. 7, 2025

(30) Foreign Application Priority Data
May 8, 2023 (AT) A 50350/2023

(51) Int. Cl. B32B 3/30

(52) U.S. Cl. CPC B32B 3/30

(57) ABSTRACT

A riblet structure for a surface for the purpose of reducing a friction resistance with respect to a fluid flowing in a main direction along the surface and use of and a method for producing such a riblet structure. The riblet structure includes a plurality of, in particular wedge-shaped, longitudinal ribs which protrude from a base surface, are oriented in the main direction, and are spaced apart from one another. To obtain a low friction resistance, it is provided that, respectively between two adjacent longitudinal ribs, the base surface includes depressions which are spaced apart from one another in the main direction, which depressions are spaced apart in a direction orthogonal to the main direction at least in sections, preferably completely, from at least one or both of the longitudinal ribs.

The invention relates to a riblet structure for a surface for the purpose of reducing a friction resistance with respect to a fluid flowing in a main direction along the surface, wherein the riblet structure comprises a plurality of, in particular wedge-shaped, longitudinal ribs which protrude from a base surface, are oriented in the main direction, and are spaced apart from one another.

The invention furthermore relates to a use of such a riblet structure.

The invention also relates to a method for producing such a riblet structure.

Riblet structures are known from the prior art. Said riblet structures are surface structures, typically in the sub-millimeter range, which are designed to reduce a friction resistance of a surface comprising the surface structure, with respect to a fluid flowing along the surface, such as air or water. Riblet structures are used, for example, on aircraft fuselages or aircraft wings of an aircraft, in order to reduce a friction resistance of the aircraft with respect to an air stream flowing along the aircraft.

Riblet structures are normally formed with longitudinal ribs which are arranged on a base level, run along a main direction that corresponds to a main flow direction of the fluid during use, and are spaced apart from one another. The longitudinal ribs are often embodied in a wedge-shape.

The document EP 3 170 743 A1, for example, discloses a riblet structure having a plurality of wedge-shaped longitudinal ribs embodied in this manner. The base surface arranged between the longitudinal ribs can be embodied to be flat or curved.

This is the starting point for the invention. The object of the invention is to specify a riblet structure of the type named at the outset which has a low friction resistance with respect to a fluid flowing along the riblet structure or a surface comprising the riblet structure.

Furthermore, an object is to specify a use of such a riblet structure.

Additionally, it is a further object to specify a method for producing such a riblet structure.

According to the invention, the object is attained in that, in the case of a riblet structure of the type named at the outset, the base surface comprises respectively between two adjacent longitudinal ribs depressions which are spaced apart from one another in the main direction, which depressions are spaced apart in a direction orthogonal to the main direction at least in sections, preferably completely, from at least one or both of the longitudinal ribs.

The basis of the invention is the finding that it is possible, in the case of a typical riblet structure that is formed with longitudinal ribs arranged on a base surface and spaced apart from one another, by introducing depressions into a base surface section located respectively between two adjacent longitudinal ribs, to influence a flow behavior of a fluid flowing along the riblet structure directly at the riblet structure, in particular in what is referred to as a viscous lower layer of a fluid-dynamic boundary layer of the fluid flow, but without causing a significant influence on or disruption of a boundary layer profile of the fluid flow somewhat more distant from the riblet structure, in particular a flow turbulence over the longitudinal ribs. There is thus the potential of improving a flow behavior directly at the riblet structure using a structural enhancement of the base surface section between the longitudinal ribs. The adjacent longitudinal ribs typically denote respectively two longitudinal ribs directly adjacent, in particular in a direction orthogonal to the main direction. The base surface is normally embodied as a base level and the base surface section as a base level section. The longitudinal ribs are normally oriented in the main direction, wherein the longitudinal ribs are arranged next to one another and spaced apart from one another in a direction orthogonal to the main direction.

Typical riblet structures with a, normally flat, base surface section between the longitudinal ribs produce a turbulent viscous resistance, largely caused by an interaction area of the base surface section located between the longitudinal ribs. It has been shown that, by introducing depressions into the base surface section, the viscous resistance can be reduced. This can be explained by a reduced interaction area of the base surface section, since an area of the base surface section located at the same height is reduced due to the introduced depressions, or a portion of the base surface is lowered by the depression, and thus merely contributes to the viscous resistance in a lesser way. In turn, however, it has been shown that an additional pressure resistance is generated by the depressions. For a riblet structure with depressions, a total resistance used for the sake of comparison thus results from a sum of the viscous resistance and pressure resistance compared to a simple viscous resistance in the case of a riblet structure without depressions. A total resistance, or friction resistance, that is advantageously reduced can thus be achieved in the case of a riblet structure with depressions if, as a result of the depressions, a reduction of the viscous resistance is as pronounced a possible on the one hand, and a pressure resistance generated in return is kept as small as possible on the other hand.

Studies have shown that this can be achieved with a pronounced delimitation of the depressions in the base surface, or a pronounced spacing, at least in sections, of the respective depression from the longitudinal ribs. This can be advantageously implemented with a base surface region that adjoins the respective depression, in particular is located between at least one of the longitudinal ribs and the depression, or a spacing of the depression at least in sections, preferably completely, from the longitudinal ribs. The cause appears to be a generation of turbulent flow at depression edge sections of the depression, in particular when a portion of the flow penetrates into the respective depression. This is related to the pressure resistance produced by the depression. This can be achieved if the respective depression is embodied to be spaced apart in a direction orthogonal to the main direction at least in sections, preferably completely, from at least one of the two longitudinal ribs. It is advantageous for a reduced viscous resistance if the depression is respectively spaced apart at least in sections, preferably completely, from both longitudinal ribs. It shall be understood that, in this case, the two longitudinal ribs denote those two directly adjacent longitudinal ribs between which the respective depression or the depressions are arranged. The base surface section typically denotes the portion of the base surface located between the two longitudinal ribs or two directly adjacent longitudinal ribs. That portion of the base surface section which comprises no depressions, or into which no depressions have been inserted, is typically referred to as the interaction area section or reference area section of the base surface. The fluid can be formed with a gas, for example air, and/or a liquid, such as water.

Respectively two directly adjacent longitudinal ribs, also referred to as a longitudinal rib pair, thereby normally form a groove between said ribs, which groove is also referred to as a longitudinal channel, wherein a groove base surface is typically formed by the base surface or a base surface section of the base surface located respectively between the longitudinal ribs and, in particular, groove side surfaces or longitudinal channel side surfaces are formed by side surfaces of the longitudinal ribs. The depressions are inserted into the base surface or the base surface section or are formed using said surface or surface section. The longitudinal ribs are usually embodied to be wedge-shaped or have a basic triangular or trapezoidal shape in a cross section orthogonal to the longitudinal extension of the longitudinal ribs. Side walls of the longitudinal ribs can be embodied to be flat. The longitudinal ribs are typically arranged on the base surface or protrude therefrom. The base surface, in particular the base surface section of the base surface located respectively between two longitudinal ribs, can be embodied to be essentially flat, wherein the depressions are additionally inserted into the base surface or are formed using said base surface. The groove thereby often essentially forms an upside-down trapezoidal recess, wherein the recess formed with the respective depression additionally connects thereto. If the base surface is embodied to be flat, it is often referred to as the base level. That region of the base surface which is not part of the depressions is also referred to as the interaction area or reference area of the base surface, or, in particular, analogously as the interaction level or reference level of the base level. Normally, the longitudinal rib height of the two longitudinal ribs or of the longitudinal rib pair is greater than a substructure or topology formed between said ribs using the base surface or the respective base surface section. Preferably, an average height of the base surface section is less than, in particular half of, preferably one-fourth of, an average longitudinal rib height of the two longitudinal ribs bordering the base surface section. A plan view, in particular of the riblet structure and/or the longitudinal channels, typically denotes a view orthogonal to the main direction and orthogonal to a secondary direction. The plan view typically occurs along the height direction. Typically, the longitudinal ribs or longitudinal channels are arranged next to one another in the secondary direction. Normally, the longitudinal ribs, in particular of the respective longitudinal channel, are arranged such that they are spaced apart from one another in the secondary direction. The secondary direction is typically oriented orthogonally to the main direction. It shall be understood that a stated height, in particular the longitudinal rib height, is typically defined in the height direction.

The height direction is normally orthogonal to the base surface or, in particular, both orthogonal to the main direction and orthogonal to the secondary direction.

The side surface of a respective longitudinal rib is typically oriented essentially parallel to the main direction. It is practicable if the side surface is embodied such that, in particular in a cross section orthogonal to the main direction, a tangent applied to the side surface has an angle between 30° and 50°, preferably approximately 40°, to the base surface or to the base surface section adjoining the side surface. This preferably applies to both side surfaces of the respective rib.

Advantageously, it is typically provided that the depressions, in particular in the main direction, are embodied with a repeating structural order, or are embodied to be arranged in a repeating manner. As a result, it is possible to realize reduced-resistance properties over a wide area in a practicable manner. This can be implemented in the main direction and/or orthogonally to the main direction. For this purpose, the depressions can form a periodic structure, in particular with regular, preferably constant, distances between said depressions. Specifically, a plurality of depression classes represented by differently embodied depressions can be present, wherein depressions from different depression classes are arranged next to one another according to a predefined order pattern. Typically, identically embodied depressions are respectively assigned to the same depression class. It is expedient if depressions from different depression classes are arranged next to one another such that they alternate, in particular periodically. For this purpose, individual depressions or groups of directly adjacent depressions from one depression class each can alternate. It is possible to arrange the depressions irregularly, but a regular arrangement or an arrangement with a structural order or order pattern is preferred. The aforementioned applies in particular in the main direction and/or orthogonally to the main direction. This holds true in particular in a cross section essentially parallel to the base surface or in a plan view of the base surface. The depressions from different depression classes can thereby differ, for example, in terms of the shape thereof, depth of the depressions, respective spacing of two directly adjacent depressions, or any other of the features described in the present document, in particular hereinafter. The aforementioned can also be implemented such that it applies to a respective base surface section.

It has been shown that, typically, a very pronounced spacing of the respective depressions from at least one, preferably both, of the longitudinal ribs is beneficial for a low pressure resistance. It is advantageous if, in a plan view of the base surface, an average spacing in a direction orthogonal to the main direction between at least one of the two longitudinal ribs and a depression edge section bordering the respective depression and facing said longitudinal rib is greater than 5%, in particular greater than 10%, preferably greater than 20%, particularly preferably greater than 25%, of an average longitudinal rib spacing between the longitudinal ribs. The longitudinal rib spacing typically denotes, in a cross section orthogonal to the main direction H, a spacing of the longitudinal ribs at the height of the base surface, or the reference area thereof, or normally such that it corresponds to a width of respective base surface section. The longitudinal rib spacing is typically measured orthogonally to the longitudinal rib height. As stated in the foregoing, with a spacing of the depression, or of a depression edge section of a depression edge of the respective depression, it is possible to influence a markedness of the resistance behavior, in particular of the viscous resistance or pressure resistance, in order to optimize said behavior. It is preferred if such a spacing is present from both of the longitudinal ribs, that is, in particular if both longitudinal ribs respectively have such a spacing from the depression edge section bordering the respective depression and facing the respective longitudinal rib. It shall be understood that the spacing from the respective longitudinal rib can thereby be different or equal. The average spacing between at least one of the two longitudinal ribs and the depression edge section bordering the respective depression and facing said longitudinal rib is normally less than 90%, in particular less than 80%, preferably less than 65%, particularly preferably less than 50%, especially preferably less than 45%, of an average longitudinal rib spacing between the longitudinal ribs. It is advantageous if the depression, preferably a centroid of the area of an area formed by the depression edge, is arranged essentially centrally between the two longitudinal ribs, that is, in particular in a direction orthogonal to the main direction essentially in the center between the two longitudinal ribs. The aforementioned spacings between the longitudinal rib and depression edge section are thereby typically determined between a point at which the respective longitudinal rib adjoins the base surface section and a point of the depression edge section.

It is expedient if the depression, in particular a depression edge segment of the depression, adjoins a base surface area which is located between the depression and one of the longitudinal ribs, in particular in a direction orthogonal to the main direction. For an optimized resistance behavior, it is beneficial if the base surface region is embodied to be essentially flat. The base surface region can connect both to the depression, or the depression edge segment, and the at least one longitudinal rib, in particular the side surface thereof. Preferably, such a base surface region is present between both of the longitudinal ribs and respectively the depression, or respectively a depression edge segment of the depression. Practicably, the depression edge segment can be the depression edge section. It is preferred if the depression or the depression edge is mostly, in particular preferably essentially completely, surrounded by such a base surface region.

A particularly pronounced reduction of the friction resistance can be obtained if, in a cross section parallel to the base surface, in particular the reference area thereof, an average longitudinal extension of the depression in the main direction is maximally 1.5 times, in particular maximally 1.2 times, as large as an average width extension of the depression in a direction orthogonal to the main direction. This particularly applies in a plan view of the base surface. In particular, it is advantageous if an area defined by the depression edge is embodied in such a manner.

It is advantageous for a reduced pressure resistance if an average depth of the depressions is less than 75%, in particular between 5% and 70%, of an average longitudinal rib height of the longitudinal ribs. It has been shown that, with greater depths, turbulences can occur which lead to an increase in the pressure resistance. Preferably, the average depth of the depression is between 5% and 60%, in particular between 10% and 45%, preferably less than 30%, particularly preferably less than 15%, of the average longitudinal rib height of the longitudinal ribs.

For the purpose of setting a viscous resistance, it is advantageous if a plurality of the depressions between the two longitudinal ribs overlap one another in a direction orthogonal to the main direction.

For a harmonization between the viscous resistance and pressure resistance, it is beneficial if the depressions form a plurality of depression rows oriented in the main direction between the longitudinal ribs or the longitudinal rib pair. For example, two rows of depressions running in the main direction can be present between the two longitudinal ribs. It is advantageous if directly adjacent depression rows are arranged such that they are offset from one another in the main direction, preferably respectively by half of a spacing of two directly adjacent depressions of one of the depression rows. A flow behavior that is advantageous in relation to the total resistance can thus be realized. The depressions between the rows can thereby overlap one another in a direction orthogonal to the main direction.

It is practicable if the respective depression mainly, in particular essentially, has a constant cross-sectional surface along a depth direction of the depression. For example, the depression can be formed with or by an essentially cylindrical or prismatic, in particular square-shaped or cube-shaped, recess. A base surface of the prism shape can thereby be polygonal, for example triangular, quadrilateral, pentagonal, or hexagonal. However, it can be beneficial for a turbulent flow behavior if the depression has at least in sections, in particular mostly, preferably essentially, a diminishing cross-sectional surface along the depth direction of the depression. The depression can, for example, be formed with or by an essentially conical or pyramidal recess. A base surface of the pyramid shape can thereby be triangular, quadrilateral, pentagonal, or hexagonal. It is expedient if, along the depth direction of the depression, the depression comprises a first depression segment with a constant cross-sectional surface along the depth direction and a second depression segment, in particular downstream from the first depression segment in the depth direction, with a diminishing cross-sectional surface along the depth direction. Preferably, the second depression segment constitutes an end segment of the depression. The cross-sectional surface of the depression is normally oriented orthogonally to the depth direction of the depression. The first or second depression segment can thereby be embodied in the aforementioned manner.

Depending on the application purpose, different shapes of depressions, in particular of cross-sectional surfaces of depressions, can be particularly beneficial. For example, the respective depression in a cross section, or the depression edge, can be formed such that it is free of corners, in particular oval or round, or can be formed such that it is polygonal, for example triangular, quadrilateral, pentagonal, or hexagonal.

It is beneficial for reducing the pressure resistance if the respective depression comprises a depression wall with which the depression is formed, which depression wall is at least in sections, in particular essentially, embodied as a rotational surface, in particular with a rotation axis in the depth direction of the depression. Thus, the depression wall can be formed with a portion of a rotational ellipsoid, in particular a spherical surface, of a rotational paraboloid, or of a rotational hyperboloid. It can be beneficial if the depression wall section is formed with a portion of a cone envelope or cylinder envelope. For example, the depression can comprise a depression wall which is essentially embodied to be dome-shaped.

It is advantageous if, in the depth direction, the respective depression is formed with a first depression region and a second depression region located after said first depression region, wherein the first depression region has a smaller diameter than the second depression region. It is thereby preferred if a diameter, in particular an area of the cross-sectional surface, of the first depression region is less than 80% of a diameter, in particular an area of the cross-sectional surface, of the second depression region. It has been shown that this is advantageous for a reduction of the pressure resistance. It is preferred if the diameter, or the area of the cross-sectional surface, of the first depression area is less than 65%, in particular between 5% and 50%, preferably between 10% and 30%, particularly preferably less than 20% of the diameter, or of the area of the cross-sectional surface, of the second depression region. In use, the cause of the advantageous effect on the pressure resistance appears to be an interaction between flows or turbulences in the different depression regions. Expediently, a plurality of, in particular a large part of, preferably essentially all of, the depressions between the two longitudinal ribs can be embodied in such a manner. The depression regions can be shaped differently, or can be respectively embodied according to the features specified with respect to the shape and size of the depression, in particular differently from one another.

It can be beneficial for a flow behavior in the depressions if a plurality of the depressions are connected to one another via at least one fluidically conductive connecting channel. Expediently, a plurality of the depressions between the two longitudinal ribs, which depressions are arranged next to one another in particular in the main direction and/or orthogonally to said main direction, can be connected to one another via at least one connecting channel. It has proven effective if the depressions are thereby directly adjacent depressions. Though a more complex design, it can be beneficial for a flow behavior if depressions between different instances of respectively two directly adjacent longitudinal ribs, or longitudinal rib pairs, are connected to one another via at least one fluidically conductive connecting channel. The connecting channel thereby typically runs underneath the longitudinal ribs in order to connect the depressions between different longitudinal rib pairs to one another. Practicably, depressions between a plurality of, a large part of, preferably essentially all of, the longitudinal rib pairs can be connected to one another via at least one or more connecting channels. Preferably, depressions which are, in particular directly, adjacent orthogonally to the main direction are connected via the at least one connecting channel, in particular if said depressions are from different longitudinal rib pairs. It shall be understood that it is beneficial if a plurality of connecting channels are provided in order to connect the depressions to one another. A plurality of connecting channels can thereby be present respectively between two depressions. The connecting channel can, for example, be formed as a bore inside of a material which forms the base surface. It has proven effective if the connecting channel connects, typically laterally, to the respective depression in a region of a bottom third of the depression, in particular in a region of a depression base.

For the purpose of setting the pressure resistance, it is advantageous if a plurality of longitudinal rib pair classes are present, wherein the longitudinal rib pair classes represent longitudinal rib pairs with different embodiments of depressions arranged between the respective longitudinal rib pair, wherein longitudinal rib pairs and respective depressions from different longitudinal rib pair classes are arranged next to one another, typically in a direction orthogonal to the main direction, according to a predefined order pattern. Thus, a longitudinal rib pair with depressions having a first depth of the depressions and a longitudinal rib pair with depressions having a second depth of the depressions can be arranged next to one another in an alternating manner, for example.

Different longitudinal rib pair classes can, for example, differ from one another in terms of a different shape of the depressions, depth of the depressions, spacing between the depressions, and/or arrangement of the depressions between the longitudinal ribs of the respective longitudinal rib pair. Typically, longitudinal rib pairs which are respectively identically embodied and depressions respectively arranged between the longitudinal ribs thereof are assigned to the same longitudinal rib pair class.

It is advantageous for a flow behavior if, on the base surface, transverse elevations are arranged which respectively connect to one of the side surfaces of one of the longitudinal ribs, wherein, in a cross section orthogonal to the main direction, the transverse elevation has a, in particular is flat, surface contour that decreases in height in a direction facing away from the side wall, and preferably transitions into the base surface. It shall be understood that this is a side surface of the longitudinal rib, which side surface faces the depressions. Typically, a plurality of transverse elevations spaced apart from one another in the main direction are provided, which transverse elevations connect to the side surface of the respective longitudinal rib. Preferably, such transverse elevations are arranged on the side surfaces of both longitudinal ribs. The side surfaces of the two longitudinal ribs are thereby typically faced towards one another. The respective transverse elevation typically transitions into the base surface, or preferably connects to one of the depressions or the depression edge thereof.

It has proven effective if the transverse elevations on side surfaces of the two longitudinal ribs, which side surfaces face one another, are present such that they connect to said side surfaces in such a way that, in a cross section orthogonal to the main direction, tangents applied to the surface contours of the transverse elevations form an angle of greater than 90°, in particular greater than 120°, with one another.

It is expedient if one of the depressions is respectively present between two directly adjacent transverse elevations. Said transverse elevations can thereby be transverse elevations directly adjacent in the main direction and/or orthogonally to the main direction. These can be directly adjacent transverse elevations which connect to the same longitudinal rib, or the side surface thereof, and/or directly adjacent transverse elevations which connect to different longitudinal ribs of the two longitudinal ribs, or the side surfaces, in particular facing one another, thereof. It is beneficial for a flow behavior if the respective transverse elevation in a plan view of the base level has a longitudinal extension oriented obliquely to the longitudinal rib longitudinal direction of the respective longitudinal rib to which the transverse elevation connects, wherein a longitudinal direction of the transverse elevation forms an acute angle with the longitudinal rib longitudinal direction. The angle can expediently be between 10° and 80°, in particular less than 60°, preferably approximately 45°.

It is typically provided that the longitudinal rib height of the longitudinal ribs and/or a longitudinal rib tip spacing between the longitudinal rib tips is less than 250 μm, in particular less than 100 μm, preferably less than 80 μm. It is beneficial if the longitudinal rib height is between 250 μm and 1 μm, in particular between 100 μm and 5 μm, preferably between 25 μm and 40 μm, particularly preferably between 30 μm and 37 μm, especially preferably approximately 34 μm. It has proven effective if the longitudinal rib tip spacing, that is, a distance between tips or peaks of directly adjacent longitudinal ribs or longitudinal rib pairs, is between 60 μm and 85 μm, in particular between 70 μm and 80 μm, preferably approximately 74 μm. Accordingly, it has proven particularly effective if the longitudinal rib height is between 30 μm and 37 μm, preferably approximately 34 μm, and the longitudinal rib tip spacing is between 70 μm and 80 μm, preferably approximately 74 μm. The longitudinal rib tip spacing is typically measured in a cross section orthogonal to the main direction between the highest points of the longitudinal ribs, or longitudinal rib tips.

Typically, it is provided that, in a cross section orthogonal to the main direction, the base surface section has a width between 50 μm and 70 μm, in particular approximately 60 μm, or the longitudinal rib spacing in said cross section has such a size. The base surface section typically adjoins the longitudinal ribs or the side walls thereof.

It is advantageous if a surface of a component is present, wherein the surface comprises a riblet structure, in particular such as that described in the present document. According to the features and effects of the riblet structure, the surface of the component can be embodied with a lower friction resistance with respect to a fluid flowing along the surface. Expediently, the component can be a part of a means of transportation, for example of an aircraft, ship, or automobile, or a part of a fluid conducting element, for example a pipe, or an article of clothing, for example a protective suit or athletic suit, in order to reduce a friction resistance of the surface of the part that comprises the riblet structure, with respect to a fluid flowing along the surface.

The object named at the outset is attained if a use of a riblet structure, in particular described in the present document, as a surface on a component is provided in order to reduce a friction between the surface and a gas flow, in particular air flow, and/or a liquid flow, in particular water flow. According to the features and effects of the riblet structure, the surface of the component can be embodied with a lower friction resistance with respect to a fluid flowing along the surface.

The other object named at the outset is attained if a method for producing a riblet structure is provided, wherein the riblet structure is embodied as described in the present document and, by an embossing or material-removing processing of a surface, the riblet structure is introduced into the surface. In this manner, it is advantageously possible to produce a riblet structure described in the present document with a low friction resistance with respect to a fluid flowing along the riblet structure. The riblet structure can be produced with the features and effects corresponding to those described in the present document. It is practicable if, for production, a negative shape of the riblet structure is used in order to introduce the riblet structure into the surface by pressing the negative form onto the surface.

It shall be understood that stated height information and depth information typically refer to a direction orthogonal to the base surface, or the reference area thereof, and statements regarding lengths and widths normally refer to a direction parallel to the base surface, or the reference area thereof.

Additional features, advantages, and effects follow from the exemplary embodiments described below. In the drawings which are thereby referenced:

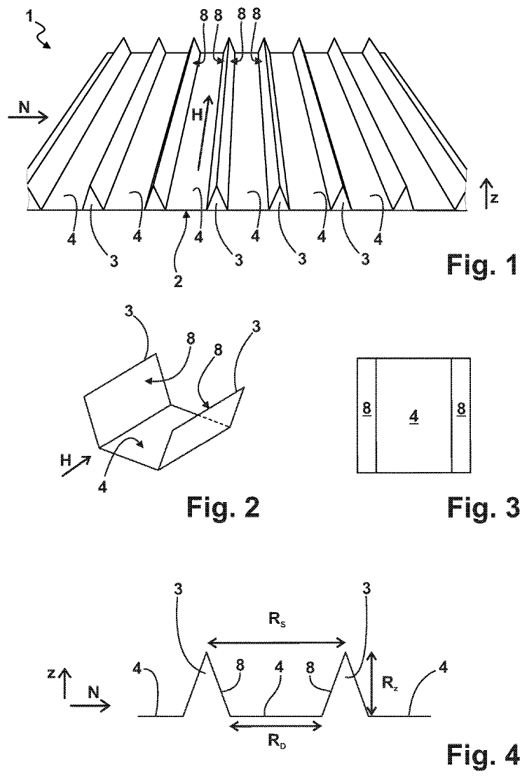

FIG. 1 shows a typical riblet structure from the prior art, with longitudinal ribs oriented in a main direction and flat base surface sections between longitudinal rib pairs;

FIG. 2 and FIG. 3 show details of the riblet structure from FIG. 1 in an oblique top view and in plan view;

FIG. 4 shows a profile illustration of a detail of the riblet structure from FIG. 1;

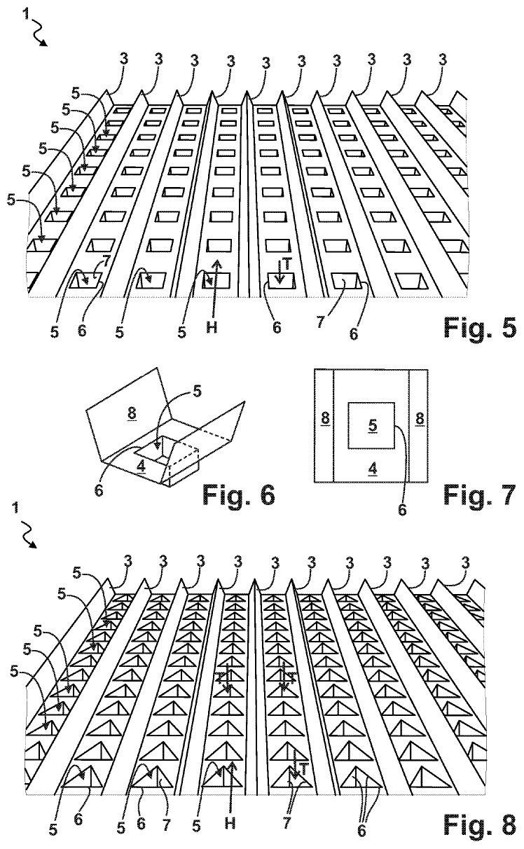

FIG. 5 shows a riblet structure with depressions spaced apart from one another in the main direction in base surface sections located between longitudinal rib pairs, wherein the depressions have a rectangular cross section;

FIG. 6 and FIG. 7 show details of the riblet structure from FIG. 5 in an oblique top view and in plan view;

FIG. 8 shows a riblet structure with depressions spaced apart from one another in the main direction in base surface sections located between longitudinal rib pairs, wherein the depressions have a triangular cross section;

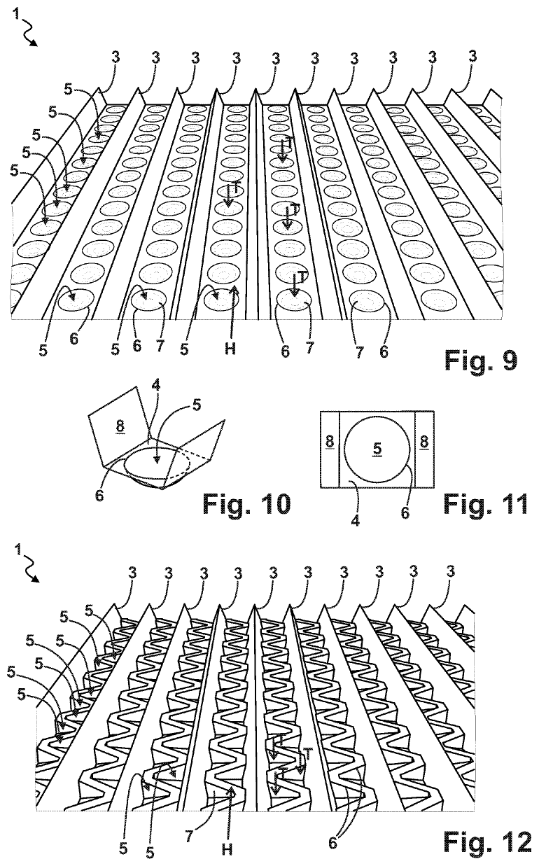

FIG. 9 shows a riblet structure with depressions spaced apart from one another in the main direction in base surface sections located between longitudinal rib pairs, wherein depression walls of the depressions are embodied as rotational surfaces;

FIG. 10 and FIG. 11 show details of the riblet structure from FIG. 9 in an oblique top view and in plan view;

FIG. 12 shows a riblet structure with depressions spaced apart from one another in the main direction in base surface sections located between longitudinal rib pairs, wherein the depressions have a triangular cross section and form two depression rows oriented in the main direction;

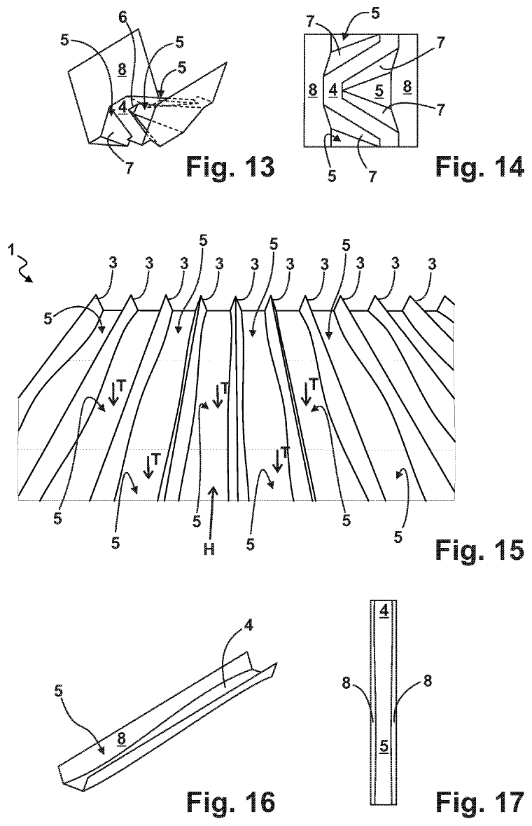

FIG. 13 and FIG. 14 show details of the riblet structure from FIG. 12 in an oblique top view and in plan view;

FIG. 15 shows a riblet structure with depressions spaced apart from one another in the main direction in base surface sections located between longitudinal rib pairs, wherein the depressions respectively extend to both longitudinal ribs of the respective longitudinal rib pair;

FIG. 16 and FIG. 17 show details of the riblet structure from FIG. 15 in an oblique top view and in plan view;

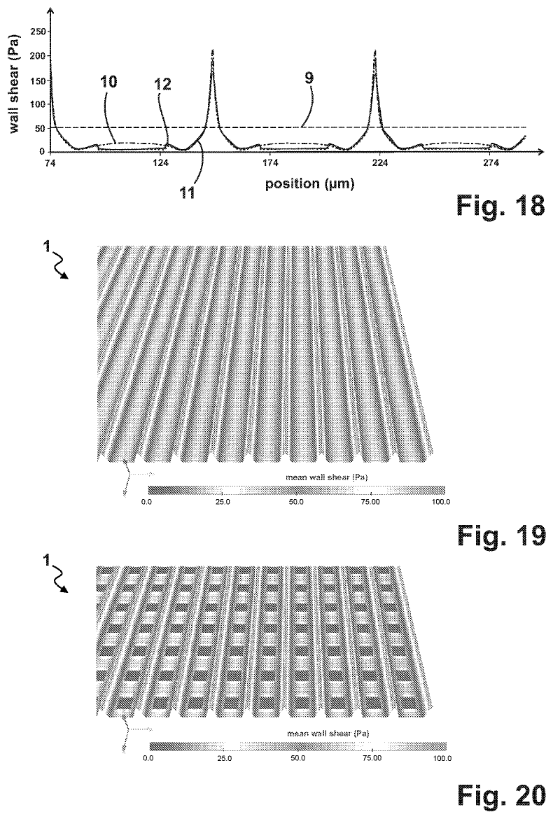

FIG. 18 shows a graph, wherein a friction resistance is illustrated as a function of position for different riblet structures;

FIG. 19 through FIG. 21 show contour diagrams for a riblet structure without depressions, a riblet structure with rectangular depressions, and a riblet structure with spherical depressions, wherein a mean friction resistance is illustrated in grayscale.

FIG. 1 shows a schematic illustration of a typical riblet structure 1 from the prior art. The riblet structure 1 is formed with a plurality of wedge-shaped longitudinal ribs 3 which protrude from a base surface 2, run in a main direction H, and are spaced apart from one another. The base surface 2 respectively forms a flat base surface section 4 between two longitudinal ribs 3, or longitudinal rib pairs, directly adjacent, typically in a secondary direction N orthogonal to the main direction. The longitudinal ribs 3 preferably comprise flat longitudinal rib side walls 8. Such a structure has proven suitable for reducing a friction resistance with respect to a fluid flowing in the main direction H along the riblet structure 1. FIG. 2 and FIG. 3 show schematic depictions of a detail of the riblet structure 1 from FIG. 1, in order to more clearly illustrate the riblet structure 1 from FIG. 1, wherein FIG. 2 shows an oblique top view and FIG. 3 shows a plan view of the riblet structure 1 from FIG. 1.

FIG. 4 shows a schematic profile depiction of a detail of the riblet structure 1 from FIG. 1. Typically, a longitudinal rib tip spacing Rₛ, a longitudinal rib spacing RD, and a longitudinal rib height R_{z}, are specified as characteristic data for describing riblet structures 1, which are measured in a cross section orthogonal to the main direction H and orthogonal to the base surface 2, in particular to a height of a respective base surface section 4. The longitudinal rib tip spacing Rₛ denotes a spacing of two directly adjacent longitudinal ribs 3 or longitudinal rib pairs, the longitudinal rib spacing Rp denotes a width of the base surface section 4 between two directly adjacent longitudinal ribs 3 or longitudinal rib pairs, and the longitudinal rib height R_{z} denotes a height of the longitudinal ribs 3, measured starting from the base surface 2 or the respective base surface section 4. This also applies analogously to the other riblet structures 1 specified herein. A height direction z is typically oriented orthogonally to the main direction H and orthogonally to the secondary direction N.

Because it is provided that the base surface 2 comprises depressions 5 which are spaced apart from one another in the main direction H respectively between two directly adjacent longitudinal ribs 3 or longitudinal rib pairs, wherein the depressions 5 are spaced apart in a direction orthogonal to the main direction H at least in sections, preferably completely, from at least one or both of the longitudinal ribs 3, it is advantageously possible to achieve a further reduction of the friction resistance.

As described below, studies and computer simulations were carried out with a plurality of different riblet structures 1, wherein in particular an extension, shape, and/or enlargement of depressions 5 introduced into the base surface 2 or base surface sections 4 were studied. A selection of studied riblet structures 1 is explained below.

FIG. 5 shows a schematic depiction of a riblet structure 1 with a basic design according to FIG. 1, wherein depressions 5 which are spaced apart from one another in the main direction H are additionally present in the respective base surface section 4 located between the longitudinal ribs 3 of a respective longitudinal rib pair. The depressions 5 have a rectangular cross section or a rectangular depression edge 6. The depressions 5 are arranged such that they are spaced apart from the longitudinal ribs 3 of the longitudinal rib pair. Such a design has proven to be very efficient for reducing the friction resistance. Expediently, the depression 5 can, along the depth direction T thereof, respectively have an essentially constant cross section or diminishing cross section. The depressions 5 then form recesses in the shape of a cube. FIG. 6 and FIG. 7 show schematic depictions of a detail of the riblet structure 1 from FIG. 5, in order to more clearly illustrate the riblet structure 1 from FIG. 5, wherein FIG. 6 shows an oblique top view and FIG. 7 shows a plan view of the riblet structure 1 from FIG. 5.

A design of a riblet structure 1 analogous to the riblet structure 1 from FIG. 5 is schematically shown in FIG. 8, wherein the depressions 5 respectively have a triangular cross section or triangular depression edge 6. The depressions 5 in FIG. 8 are also embodied such that they are spaced apart from the two longitudinal ribs 3 of the longitudinal rib pair and, in particular, can, with along the depth direction T thereof, be embodied with a constant cross section or diminishing cross section.

FIG. 9 shows a schematic depiction of a further riblet structure 1 with a basic design according to FIG. 1 and FIG. 5, wherein the depressions 5 are embodied with depression edges that are free of corners. The depressions 5 can advantageously comprise depression walls 7 which are embodied as rotational surfaces, typically with rotation axes in the depth direction T of the depressions 5. It has proven effective if the depression walls 7 of the depressions 5 are embodied as part of a rotational ellipsoid, preferably of a spherical surface, or spherically. Depressions 5 embodied in such a manner are particularly suitable for realizing a reduced viscous resistance with a simultaneously minimized pressure resistance. In FIG. 9, the depressions 5 are essentially embodied as part of a sphere or spherical surface. FIG. 10 and FIG. 11 show schematic depictions of a detail of the riblet structure 1 from FIG. 9, in order to more clearly illustrate the riblet structure 1 from FIG. 9, wherein FIG. 10 shows an oblique top view and FIG. 11 shows a plan view of the riblet structure 1 from FIG. 9.

FIG. 12 shows a schematic depiction of a riblet structure 1 with a basic design according to FIG. 1, wherein the respective base surface section 4 located between the longitudinal rib pairs comprises depressions 5 spaced apart from one another in the main direction H, wherein the depressions 5 form two depression rows oriented in the main direction H. The depression rows are arranged such that they are next to one another or offset in a direction orthogonal to the main direction H, as can be seen in particular in a view in the main direction H, wherein the depression rows are offset or displaced relative to one another in the main direction H, typically by half of a spacing between two directly adjacent depressions 5 of one of the depression rows. As can be seen in FIG. 12, a reference area of the base surface section 4, that is, a portion of the base surface section 4 without depressions 5, can thus form a zig-zag structure running back and forth between the two rows. FIG. 13 and FIG. 14 show schematic depictions of a detail of the riblet structure 1 from FIG. 12, in order to more clearly illustrate the riblet structure 1 from FIG. 12, wherein FIG. 13 shows an oblique top view and FIG. 14 shows a plan view of the riblet structure 1 from FIG. 12. With design of this type, a reduced viscous resistance and simultaneously low pressure resistance can be realized, so that the friction resistance can be advantageously reduced, in particular in comparison with the design according to FIG. 1. The pressure resistance thereby typically cannot be minimized to the same extent as in an embodiment of the depressions 5 with depressions walls 7 in the shape of rotational surfaces, such as according to FIG. 9 for example.

FIG. 15 shows a schematic depiction of a riblet structure 1 with a basic design according to FIG. 1, wherein the base surface section 4 comprises depressions 5 spaced apart from one another in the main direction H. In this case, however, it is provided that the depressions 5 extend to both longitudinal ribs 3 of the respective longitudinal rib pair, so that, in the main direction H, a type of sinusoidal course of the base surface section 4 results. FIG. 16 and FIG. 17 show schematic depictions of a detail of the riblet structure 1 from FIG. 15, in order to more clearly illustrate the riblet structure 1 from FIG. 15, wherein FIG. 16 shows an oblique top view and FIG. 17 shows a plan view of the riblet structure 1 from FIG. 15. With a shape of this type, a reduction of the friction resistance compared to a flat surface without a riblet structure 1 was obtained, but the friction resistance was higher than with a riblet structure 1 having a flat base surface 2 without depressions 5 according to FIG. 1.

Simulation results for the aforementioned design variants are presented below. For the data provided below, 84 longitudinal ribs 3 arranged on a base surface 2 with a longitudinal rib tip spacing Rₛ respectively between two directly adjacent longitudinal ribs 3 of 74 μm and a longitudinal rib height R_{z} of 34 μm were used. Water with a temperature of 25° C. was used as fluid.

For the riblet structures 1 from FIG. 1—without depressions 5—, FIG. 5—rectangular depressions 5—, FIG. 8—triangular depressions 5—, FIG. 9—spherical depressions 5—, FIG. 12—triangular depressions 5 in two rows—, and FIG. 15—depressions 5 extending to both longitudinal ribs 3—, the results for resistance parameters with respect to the fluid flowing in the main direction H along the riblet structure 1 are stated in Table 1 below. A total resistance P_{S} thereby results as the sum of the pressure resistance Pp and viscous resistance P_{V}. Finally, the percentage reduction of the friction resistance compared to a flat surface without a riblet structure 1 is also stated in Table 1.

As shown in Table 1, there results for a typical riblet structure 1 from FIG. 1, with no depressions 5 provided, a reduction in the friction resistance of 8.10% compared to a flat surface without a riblet structure 1. By comparison, more marked reductions in the friction resistance are obtained by the riblet structures 1 from FIG. 5, FIG. 8, FIG. 9, and FIG. 12. Whereas a riblet structure 1 from FIG. 1 has a viscous resistance and virtually no pressure resistance, providing depressions 5 in the base surface sections 4 reduces the viscous resistance, but in turn produces a pressure resistance. If both of these resistances are minimized, a reduction in the friction resistance of a riblet structure 1 with depressions 5 compared to a surface without a riblet structure 1 can be obtained, which reduction is greater than in the case of a riblet structure 1 from FIG. 1 without depressions 5.

A particularly advantageous reduction in the friction resistance of 9.94% results with the riblet structure 1 from FIG. 8—depressions 5 triangular in cross section, which riblet structure 1 comprises depressions 5 spaced apart from both longitudinal ribs 3. In the case of the riblet structure 1 from FIG. 5—depressions 5 rectangular in cross section—, a reduction in the friction resistance of 8.57% and, in the case of the riblet structure from FIG. 9—depressions 5 which comprise depressions walls 7 embodied as part of a spherical surface—, a reduction in the friction resistance of 8.56% compared to a surface without a riblet structure 1 is achieved. In the case of the riblet structure 1 from FIG. 12—triangular depressions 5 in two rows—, a reduction in the friction resistance of 9.53% results. With the riblet structure 1 from FIG. 15—depressions 5 that extend to both longitudinal ribs 3—, it was, by contrast, only possible to achieve a 7.22% reduction in the friction resistance compared to a surface without a riblet structure 1, that is, less of a reduction than in the case of a riblet structure 1 from FIG. 1 without depression 5.

TABLE 1
Simulation results for a friction resistance of the riblet structures
1 from FIG. 1 - without depressions 5 -, FIG. 5 - rectangular depressions
5 -, FIG. 8 - triangular depressions 5 -, FIG. 9 - spherical depressions
5 -, FIG. 12 - triangular depressions 5 in two rows -, and FIG. 15 -
depressions 5 extending to both longitudinal ribs 3 -, with P_{P} the
pressure resistance, P_{V} the viscous resistance, P_{S} the total resistance
(P_{P} + P_{V}), and ΔR the percentage change in the friction resistance
compared to a flat surface without a riblet structure 1.

| | P_{P} (N) | P_{V} (N) | P_{S} (N) | ΔR (%) |
|---|---|---|---|---|
| Structure | 0 | 0.00097968 | 0.00097968 | −8.10 |
| from FIG. 1 | | | | |
| Structure | 0.00003456 | 0.00094015 | 0.00097471 | −8.57 |
| from FIG. 5 | | | | |
| Structure | 0.00004348 | 0.00091659 | 0.00096007 | −9.94 |
| from FIG. 8 | | | | |
| Structure | 0.00001435 | 0.00096040 | 0.00097474 | −8.56 |
| from FIG. 9 | | | | |
| Structure | 0.00003463 | 0.00092976 | 0.00096440 | −9.53 |
| from FIG. 12 | | | | |
| Structure | 0.00000448 | 0.00098458 | 0.00098906 | −7.22 |
| from FIG. 15 | | | | |

FIG. 18 shows a graph in which the friction resistance for different riblet structures 1 is illustrated as a function of the position in a direction orthogonal to the main direction H. Line 10, depicted as a dot-dashed line, shows the friction resistance for a riblet structure 1 without depressions 5 according to FIG. 1. Visible are periodic peaks of the line 10 which correspond to the longitudinal ribs 3 of the riblet structure 1. Between the peaks, the line 10 respectively forms a valley progression with a slightly parabolic increase in the friction resistance centrally between adjacent peaks. Line 11, depicted as a dotted line, shows the friction resistance for a riblet structure 1 with rectangular depressions 5 according to FIG. 5, and line 12, depicted as a solid line, shows the friction resistance for a riblet structure 1 with spherical depressions 5 according to FIG. 9. The lines 11 and 12 likewise have a basic shape of the line 10, though in contrast to the line 10, the peaks of the lines 11 and 12 have a lower height and, in the center between the peaks, a decrease or depression in the friction resistance is present in the line 11 and 12. This corresponds to the depressions 5 of the riblet structures 1 from FIG. 5 and FIG. 9, respectively, and to the reduction in the total resistance caused by the depressions 5. For the sake of comparison, the graph from FIG. 18 also shows with the line 9, illustrated as a dashed line, a friction resistance for a flat surface without a riblet structure 1. The line 9 shows a constant friction resistance along the surface.

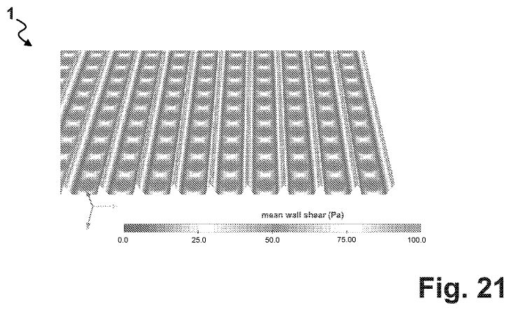

FIG. 19 through FIG. 21 shows contour diagrams for a mean friction resistance of different riblet structures 1, wherein the friction resistance is represented by grayscale. FIG. 19 shows a riblet structure 1 according to FIG. 1—without depressions 5—, FIG. 20 shows a riblet structure according to FIG. 5—rectangular depressions 5—, and FIG. 9 shows a riblet structure 1 according to FIG. 9—spherical depressions 5. Evident in the contour diagrams is—corresponding to the graph from FIG. 18—the fact that a reduced mean friction resistance is present between the longitudinal ribs 3. The rectangular depressions 5 of the riblet structure 1 according to FIG. 5 correspond in FIG. 20 to rectangular dark regions of a particularly reduced friction resistance, and the spherical depressions 5 from FIG. 9 correspond in FIG. 21 to circular dark regions of a particularly reduced friction resistance. The light regions located between the circular dark regions in FIG. 21 also correspond to a smaller friction resistance than the light regions of FIG. 20 located between the rectangular dark regions. This corresponds to the finding of a particularly reduced friction resistance in the case of spherical depressions 5 or depressions 5 with a depression edge 6 free of corners.

With a riblet structure 1, wherein the riblet structure 1 comprises a plurality of longitudinal ribs 3 which protrude from a base surface 2, are oriented in a main direction H, and are spaced apart from one another, it is thus possible to achieve an advantageously small friction resistance of the riblet structure 1 with respect to a fluid flowing in the main direction H along the riblet structure, in that, respectively between two adjacent longitudinal ribs 3, or longitudinal rib pairs, the base surface 2 or the base surface section 4 comprises depressions 5 spaced apart from one another, wherein the depressions 5 are spaced apart from at least one, preferably both, longitudinal ribs 3 in a direction orthogonal to the main direction H. As a result, it is possible to both reduce a viscous resistance and minimize a pressure resistance, so that a pronounced reduction of a friction resistance of the riblet structure 1 can be achieved. This applies in particular if the depressions 5 have a pronounced spacing from both longitudinal ribs 3 and are preferably positioned centrally between the longitudinal ribs 3. An embodiment of the depressions 5 with a rectangular cross section or with a depression wall 7 that is a part of a rotational ellipsoid, preferably of a sphere or spherical surface, has proven to be particularly beneficial for obtaining a small friction resistance.

1. A riblet structure for a surface for the purpose of reducing a friction resistance with respect to a fluid flowing in a main direction along the surface, wherein the riblet structure comprises a plurality of, in particular wedge-shaped, longitudinal ribs which protrude from a base surface, are oriented in the main direction, and are spaced apart from one another, wherein, respectively between two adjacent longitudinal ribs, the base surface comprises depressions spaced apart from one another in the main direction, which depressions are spaced apart in a direction orthogonal to the main direction at least in sections, preferably entirely, from at least one or both of the longitudinal ribs.

2. The riblet structure according to claim 1, wherein the depressions, in particular in the main direction, are embodied with a repeating structural order.

3. The riblet structure according to claim 1, wherein, in a plan view of the base surface, an average spacing in a direction orthogonal to the main direction between at least one of the two longitudinal ribs and a depression edge section bordering the respective depression and facing said longitudinal rib is greater than 5% of an average spacing between the longitudinal ribs.

4. The riblet structure according to claim 1, wherein, in a cross section parallel to the base surface, an average longitudinal extension of the depression in the main direction is maximally 1.5 times, in particular maximally 1.2 times, as large as an average width extension of the depression in a direction orthogonal to the main direction.

5. The riblet structure according to claim 1, wherein the depressions form a plurality of depression rows oriented in the main direction between the two longitudinal ribs.

6. The riblet structure according to claim 5, wherein the depression rows are arranged such that they are offset from one another in the main direction, preferably respectively by half of a spacing between two adjacent depressions of an adjacent row.

7. The riblet structure according to claim 1, wherein the respective depression mainly has a constant cross-sectional surface along a depth direction of the depression.

8. The riblet structure according to claim 1, wherein, in a cross section, the respective depression is formed such that it is free of corners, in particular oval or round, or is formed such that it is polygonal, in particular triangular or quadrilateral.

9. The riblet structure according to claim 1, wherein the respective depression comprises a depression wall which forms the depression, which depression wall is at least in sections embodied as a rotational surface, in particular with a rotation axis in the depth direction of the depression.

10. The riblet structure according to claim 1, wherein, in the depth direction, the respective depression is formed with a first depression region and a second depression region located after said first depression region, wherein the first depression region has a smaller diameter than the second depression region, preferably a diameter of the first depression region is less than 80% of a diameter of the second depression region.

11. The riblet structure according to claim 1, wherein a plurality of the depressions are connected to one another via at least one fluidically conductive connecting channel.

12. The riblet structure according to claim 1, wherein a longitudinal rib height of the longitudinal ribs and/or a longitudinal rib spacing between the longitudinal ribs is less than 250 μm, in particular less than 100 μm.

13. A surface of a component, wherein the surface comprises a riblet structure according to claim 1.

14. A use of a riblet structure according to claim 1 as a surface for a component in order to reduce a friction between the surface and a gas flow, in particular air flow, and/or a liquid flow, in particular water flow.

15. A method for producing a riblet structure, wherein the riblet structure is embodied according to claim 1, wherein the riblet structure is, by an embossing or material-removing processing of a surface, introduced into the surface.
